(19) United States
(12) Patent Application Publication
(10) Pub. No.: US 2014/0136599 A1
(43) Pub. Date: May 15, 2014

(54) METHOD, SYSTEM AND COMPUTER READABLE STORAGE MEDIUM FOR NOTIFICATION AND PROVIDING QUICK LINK OF SHARED INFORMATION SYNCHRONIZED TO LOCATION

(71) Applicant: INSTITUTE FOR INFORMATION INDUSTRY, Taipei (TW)

(72) Inventors: Bang-Min SHIUE, Taipei City (TW); Yu-Lin JENG, Tainan City (TW)

(73) Assignee: INSTITUTE FOR INFORMATION INDUSTRY, TAIPEI (TW)

(21) Appl. No.: 13/706,353

(22) Filed: Dec. 6, 2012

(30) Foreign Application Priority Data
Nov. 14, 2012 (TW) 101142399

(51) Int. Cl. H04L 29/06

(52) U.S. Cl. CPC H04L 67/42
USPC 709/203

(57) ABSTRACT

A method for notification and providing quick link of shared information synchronized to location includes the following steps. Shared information uploaded from one local client device is received. The shared information is synchronized and distributed to another local client device. A shortcut link containing a saving path for instantly activating the shared information synchronized in another local client device is provided and sent to the another local client device.

### RELATED APPLICATIONS

This application claims priority to Taiwan Application Serial Number 101142399, filed Nov. 14, 2012, which is herein incorporated by reference.

### BACKGROUND

1. Technical Field

The present invention relates to a method, system and computer readable storage medium for notification and providing quick link of shared information synchronized to location.

2. Description of Related Art

With rapid development of computer technology and Internet network construction, appliances of Cloud Computing Technology are increasingly popular. The so-called Cloud Computing Technology is to communicate computation tasks among a plurality of computer systems via a network, or to enable one of the computer systems to obtain network services provided from a remote cloud server via the network. In Cloud Computing Technology, a cloud storage service enables one of users to access information stored in storage space of the remote cloud server via a network, or enables all of the users in the same group to share information with each other via the network, thereby overcoming the shortcoming that large sized files or specific files fail to be transmitted to others by attaching files in an e-mail, thus further decreasing the difficulty of information sharing.

However, when each of local client devices receives shared information synchronized from a cloud storage service, the shared information is directly saved into a predetermined folder of the local client device according to a previously setting therein, thus, the user of the local client device cannot instantly learn that whether the shared information has been downloaded, who provides the shared information and where the shared information can be obtained in the local client device, so that the user has to check and find the shared information via a lengthy saving path which is prolix and unfamiliar.

### SUMMARY

One aspect of the present invention is to disclose a method for notification and providing quick link of shared information synchronized to location. When a cloud server synchronizes shared information to all local client devices, the cloud server instantly provides a convenient shortcut link design for instantly activating the synchronized shared information to the local client devices, so that users can choose to instantly activate the shared information by the shortcut link without needing to check and find the shared information via a lengthy saving path which is prolix and unfamiliar.

The method for notification and providing quick link of shared information synchronized to location may be implemented as a computer program product, which includes at least one program instruction. The at least one program instruction of the computer program product is to be loaded into a computer. After the at least one program instruction of the computer program product is loaded into the computer, the computer executes the steps of the method for notification and providing quick link of shared information synchronized to location. The method for notification and providing quick link of shared information synchronized to location is implemented on a cloud server, and includes the following steps:

(a) receiving shared information uploaded from a first local client device via a network;

(b) synchronizing and distributing the shared information to at least one second local client device on the network, and designating a predetermined saving path through which the shared information is saved to the second local client device; and

(c) generating and sending a shortcut link to the second local client device, wherein when the shortcut link is triggered in the second local client device, the shared information is activated instantly.

In one of embodiments of the present invention, the step (c) further comprises the following steps. Contact information for contacting the second local client device is obtained according to a membership account ID of the first local client device. A message containing the shortcut link is sent to the second local client device according to the contact information.

In one of embodiments of the present invention, a first stage folder of the saving path is named according to the membership account ID of the first local client device.

In one of embodiments of the present invention, the contact information is an e-mail address, an account ID of instant messaging software or a mobile phone number.

In one of embodiments of the present invention, the step (c) further comprises the following steps. Background information of the first local client device and the shared information are written into the message.

In one of embodiments of the present invention, the message is an e-mail, a message of an instant messaging software or a short message of Short Message Service.

In one of embodiments of the present invention, when the message is the e-mail, the shortcut link exists in a content of the e-mail or in an attached file of the e-mail.

In one of embodiments of the present invention, the shared information is at least one file or a folder having at least one file.

In one of embodiments of the present invention, after it is determined that the step (b) is completed, the step (c) is then performed.

In one of embodiments of the present invention, the step (b) and the step (c) are performed simultaneously.

In one of embodiments of the present invention, the step (b) further comprises the following step. After it is determined that the shared information is uploaded from the first local client device at a first time, the step (c) is then performed.

Another aspect of the present invention is to disclose a system for notification and providing quick link of shared information synchronized to location. When a cloud server synchronizes shared information to local client devices, the cloud server instantly provides a convenient shortcut link design for instantly activating the synchronized shared information to the local client devices, so that users can choose to activate the shared information instantly by the shortcut link without needing to check and find the shared information via a lengthy saving path which is prolix and unfamiliar.

According to another embodiment of this invention, the system for notification and providing quick link of shared information synchronized to location comprises a first local client device, a second local client device and a cloud server. The cloud server comprises a network interface unit, a data synchronization module, and a shortcut link generator. The network interface unit is used for establishing a connection with the first local client device and the second local client device via networks. The data synchronization module is used for synchronizing at least one shared information from the first local client device to the second local client device via the network interface unit, and designating a predetermined saving path which the shared information is saved to the second local client device according to the designated saving path. The shortcut link generator is used for generating a shortcut link according to the saving path. The shortcut link is sent to the second local client device via the network interface unit. When the shortcut link is triggered in the second local client device, the shared information is activated instantly.

In one of embodiments of the present invention, the system for notification and providing quick link of shared information synchronized to location further comprises a message management module electrically connected to the network interface unit and the shortcut link generator for providing and sending a message containing the shortcut link to the second local client device via the network interface unit according to contact information of the second local client device.

In one of embodiments of the present invention, the system for notification and providing quick link of shared information synchronized to location further comprises a membership database including a membership account ID of the first local client device, and the contact information of the second local client device chosen to be shared with information from the first local client device.

In one of embodiments of the present invention, a first stage folder of the saving path is named according to the membership account ID of the first local client device.

In one of embodiments of the present invention, the second local client device comprises a storage unit and an agent program module electrically connected to the storage unit for saving the shared information synchronized from the cloud server to the storage unit according to the saving path designated by the cloud server.

The present invention can achieve many advantages. After any of the local client devices receives shared information synchronized from the cloud server, the local client device can instantly find and activate the shared information immediately or when needing to view the shared information, by triggering the shortcut link directing to a storing path for instantly activating the shared information in the local client device without needing to check and find the shared information via a lengthy saving path which is prolix and unfamiliar, thus shortening working time and increasing working effectiveness.

These and other features, aspects, and advantages of the present invention will become better understood with reference to the following description and appended claims. It is to be understood that both the foregoing general description and the following detailed description are by examples, and are intended to provide further explanation of the invention as claimed.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a functional block diagram showing a system for notification and providing quick link of shared information synchronized to location under cloud storage services architecture, according to an embodiment of the present invention;

FIG. 2 is a functional block diagram showing a cloud server of FIG. 1;

FIG. 3 is a functional block diagram showing a local client device of FIG. 1;

FIG. 4A is a schematic view illustrating an e-mail according to one embodiment of the present invention;

FIG. 4B is a schematic view illustrating a message of instant messaging software according to one embodiment of the present invention; and

FIG. 5 is a flow chart showing a method for notification and providing quick link of shared information synchronized to location, according to an embodiment of the present invention.

### DESCRIPTION OF THE EMBODIMENTS

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

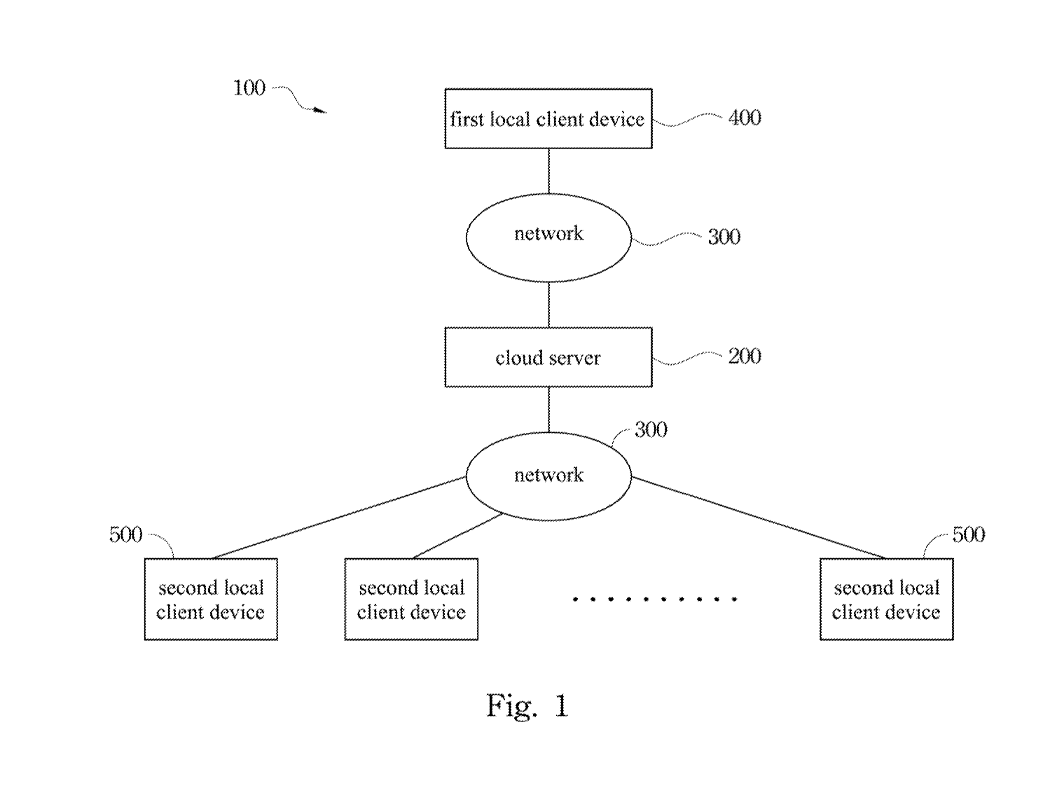

Reference is now made to FIG. 1, in which FIG. 1 is a functional block diagram showing a system 100 for notification and providing quick link of shared information synchronized to location under cloud storage services architecture, according to an embodiment of the present invention.

Referring to FIG. 1, the system 100 for notification and providing quick link of shared information synchronized to location, includes a cloud server 200 and a plurality of local client devices (e.g., a first local client device 400 and a plurality of second local client devices 500 shown in FIG. 1). The local client devices respectively establish a connection with the cloud server 200 via a network 300 so as to backup and share information in the cloud server 200.

All of the second local client devices 500 are chosen to be shared with information by the first local client device 400. Thus, when the first local client device 400 (or called as a sharing local client device) is desired to synchronize shared information to the cloud server 200, and after the cloud server 200 has backed up the shared information, the cloud server 200 transmits the shared information to all of the second local client devices 500 (or each called as a shared local client device), simultaneously, so as to enable a latest version of the shared information to be stored or updated to a specific storage location of all of the second local client devices 500. Thus, the aforementioned action is defined that the cloud server 200 synchronizes the specific shared information to the specific storage location of all of second local client devices 500.

Furthermore, the cloud server 200 further respectively notifies users of all of the second local client devices 500 that external shared information is now synchronized to all of the second local client devices 500. Also, the cloud server 200 provides a function for allowing the specific shared information to be instantly found and viewed by the users of all of the second local client devices 500. Thus, the users of all of the second local client devices 500 can instantly activate the shared information each stored in the respective local client device via a shared link respectively without needing to check and find the shared information via a lengthy saving path which is prolix and unfamiliar, thus shortening working time and increasing working effectiveness.

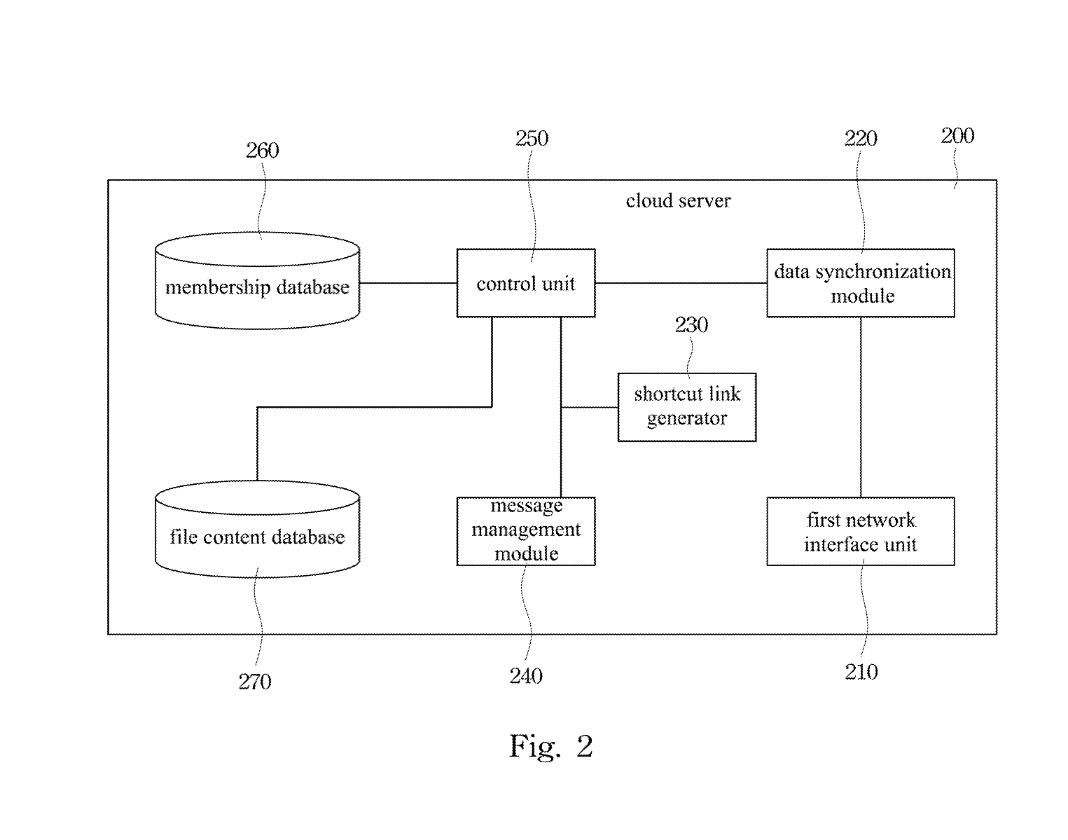

FIG. 2 is a functional block diagram showing a cloud server 200 of FIG. 1. Referring to FIG. 1 and FIG. 2, the cloud server 200 comprises a first network interface unit 210, a data synchronization module 220, a shortcut link generator 230, a message management module 240 and a control unit 250. Since the first network interface unit 210 has IP addresses of all of the local client devices (including the first local client device 400 and the second local client devices 500), the first network interface unit 210 can establish a connection with all of the local client devices (including the first local client device 400 and the second local client devices 500) via the network 300, respectively. The data synchronization module 220 electrically connects the first network interface unit 210 to the control unit 250, and synchronizes the shared information to all of the second local client devices 500 after receiving the shared information uploaded from the first local client device 400 (i.e. the aforementioned shared local client device). Specifically, the data synchronization module 220 further designates a predetermined saving path for synchronization such that the shared information can be saved to a specific storage location of all of the second local client devices 500 according to the predetermined saving path. The shortcut link generator 230 is electrically connected to the message management module 240 and the control unit 250, and generates a shortcut link 900 according to the saving path. The message management module 240 is electrically connected to the first network interface unit 210, the shortcut link generator 230 and the control unit 250, and provides a message containing the shortcut link 900 therein and sends the message to all of the second local client device 500 via the first network interface unit 210 according to contact information of all of the second local client devices 500. The shortcut link 900 can be presented as texts or graphics in the message, and have a hyperlink form for linking to the shared information saved in the second local client device 500.

Moreover, the cloud server 200 further comprises a plurality of databases, such as a membership database 260 and a file content database 270. The membership database 260 at least contains relevant background information of the users of all of the local client devices. Each relevant background information can be, for example, a membership account ID, a password, an e-mail address, preference sets, and other membership account ID(s) (multi-selectable) chosen to be shared with information by the respective membership account ID, and contact information of these membership account ID(s) to be shared information. The contact information can be, for example, an e-mail address or land an account ID of an instant messaging software or land a mobile phone number, etc. Substantially, after the data synchronization module 220 receives the shared information uploaded from the first local client device 400 (i.e. the sharing local client device), the shared information is backed up into the file content database 270.

The control unit 250 is electrically connected to the data synchronization module 220, the message management module 240, the first network interface unit 210 and the aforementioned databases (e.g. the membership database 260 and the file content database 270), and instructs the aforementioned elements in the cloud server 200 to process their own tasks and to access the aforementioned databases (e.g. the membership database 260 and the file content database 270).

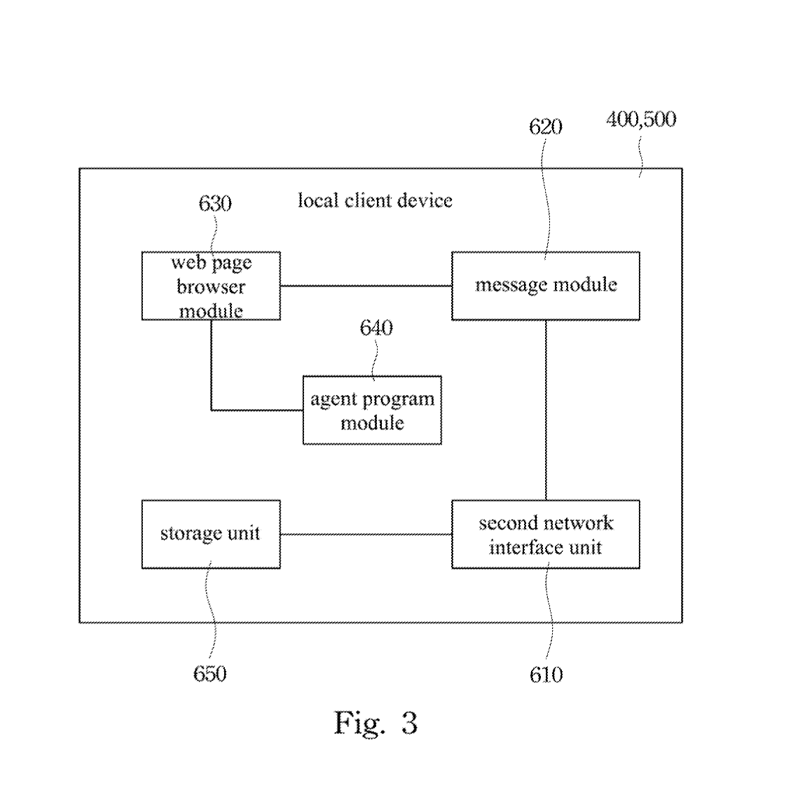

FIG. 3 is a functional block diagram showing a local client device of FIG. 1. Referring to FIG. 1 and FIG. 3, each local client device (e.g., the first local client device 400 or the second local client device 500) comprises a second network interface unit 610, a message module 620, a web-page browser module 630, an agent program module 640, and at least one storage unit 650.

With a default IP address of the cloud server 200, the second network interface unit 610 can establish a connection with the cloud server 200 via the network 300. The message module 620 is electrically connected to the second network interface unit 610, and provides the aforementioned messages to the user of the respective local client device for reading after receiving the aforementioned messages via the second network interface unit 610.

The web-page browser module 630 electrically connects the message module 620 to the agent program module 640, and when the shortcut link 900 of the aforementioned message is triggered, the web-page browser module 630 sends an execution request corresponding to the shortcut link 900 to the agent program module 640.

The agent program module 640 is electrically connected to the second network interface unit 610 and the storage unit 650, and executes the shared information of the synchronization tasks requested by the data synchronization module 220 of the cloud server 200. The agent program module 640 further saves the shared information synchronized from the data synchronization module 220 of the cloud server 200 to the storage unit 650 according to the saving path designated by the data synchronization module 220 of the cloud server 200.

The storage unit 650 can be a non-volatile memory, and the types of the non-volatile memory can be a flash memory, a floppy disk, a hard disk, a CD-ROM, a USB flash drive and a tape etc.

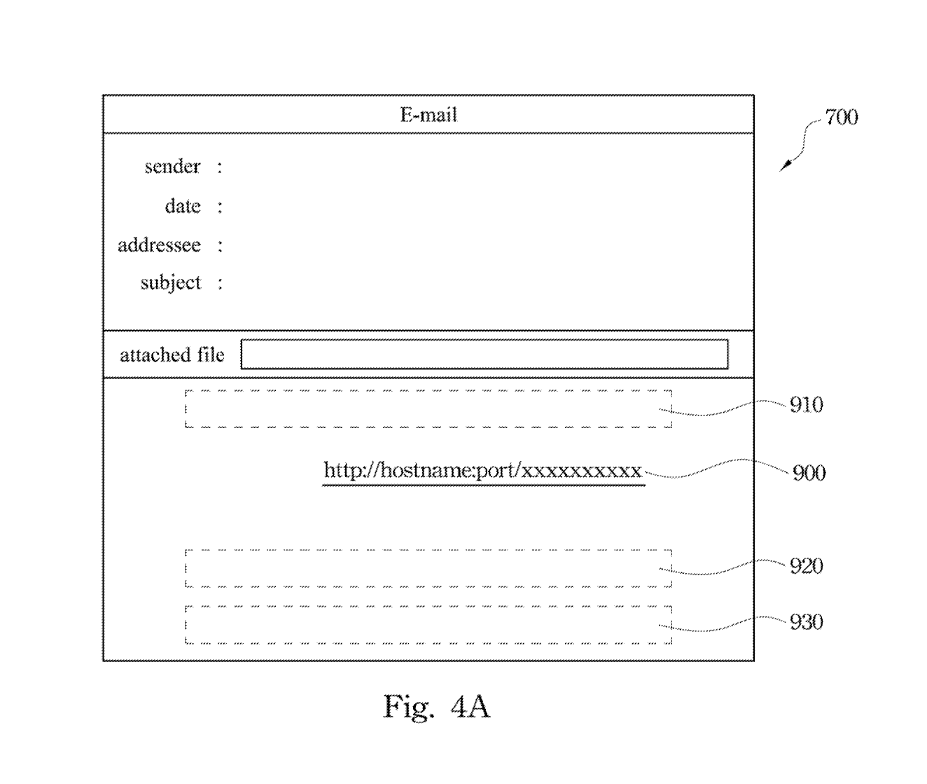

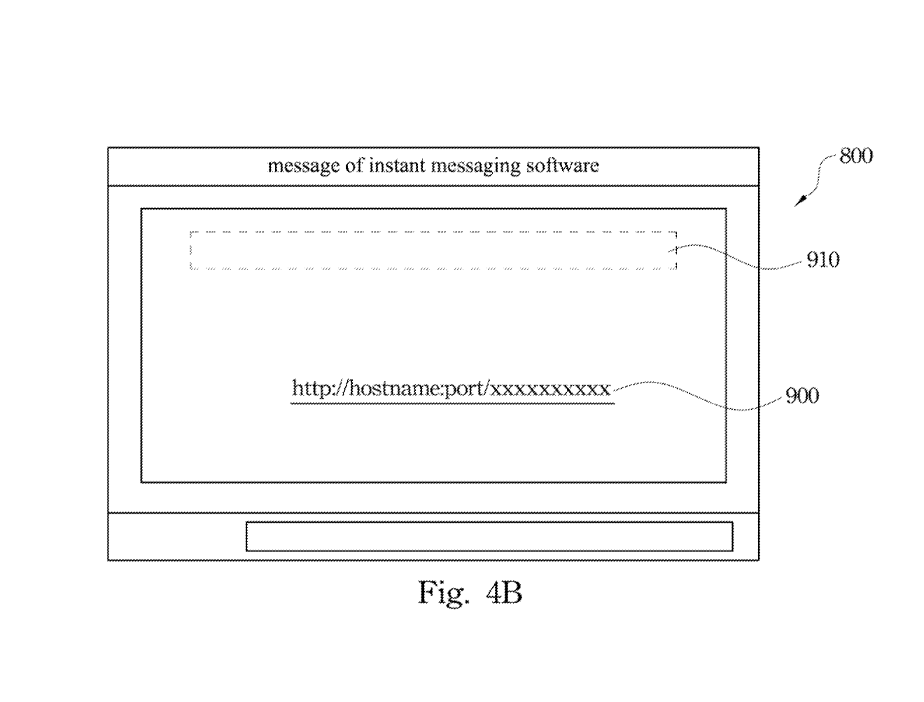

Reference is now made to FIG. 4A and FIG. 4B in which FIG. 4A is a schematic view illustrating an e-mail 700 according to one variation of the practice of the present invention, and FIG. 4B is a schematic view illustrating a message 800 of instant messaging software according to one variation of the practice of the present invention.

Also, the message can be for example, an e-mail, a message of an instant messaging software (e.g., MSN®, YAHOO®, QQ®, SKYPE®, LINE® or WhatsApp®) or a short message of Short Message Service (SMS) etc.

Referring to FIG. 4A, when the message is an e-mail 700, the shortcut link 900 is shown as texts of the saving path and with a hyperlink form in the content of the e-mail 700, or the shortcut link 900 itself exists in an attached file of the e-mail 700. Referring to FIG. 4B, when the message is a message 800 of instant messaging software (or when the message is a short message of Short Message Service not shown in figures), the shortcut link 900 is shown as texts, mojibakes or graphics and with a hyperlink form in a frame of the instant messaging software. As shown in FIG. 4A, the texts of the saving path shown in the message can be shown as “http://hostname:port/xxxxxxxxxx”.

However, as long as a message has a shortcut link 900 shown therein, and the shortcut link 900 can be clicked for activating the shared information directly by linking to the saving path of the shared information in the local client device, the formation of the so-called message should not be limited, such as the message can be with or without any notification contents.

Specifically, in one embodiment, the aforementioned message also can contain predetermined notification content 910 therein (FIG. 4A and FIG. 4B). The predetermined notification content 910, for example, can be presented as “Jack is sharing a shared information to you, please click the following shortcut link for activating the shared information”

In another embodiment, the aforementioned message also can include background information 920 (e.g., name or IP address) of the sharing local client device or/and relevant background information 930 (e.g., file name, type and size) of the shared information (FIG. 4A).

It is noted that the aforementioned cloud server 200 can be defined as a single or a plurality of server hosts responsible of operating the information synchronization, backup or other cloud computing service tasks in the system 100, the aforementioned local client device (including the first local client device 400 and the second local client devices 500) can be any generalized concept of a computer device capable of connecting the cloud server 200 via the network 300 and having a storage unit 650 with sufficient capability space, and the aforementioned local client device, for example, can be a desktop computer, a notebook computer, a tablet computer, a personal digital assistant, a smart phone, an electrical dictionary device, a game console or a GPS computer etc., and the aforementioned network 300 can be one single or a plurality of wide area networks (WAN) e.g., Internet or intranet, and the aforementioned saving path can be provided according to a predetermined set given by a vendor of the cloud server 200, or according to a predetermined set given from the preference sets of the relevant background information stored in the membership database 260.

The shared information is not limited to being saved in one disk, directly, a first stage folder in one disk or a plurality of multi-staged sub-folders in one disk. In one embodiment, the agent program module 640 can name a first stage folder of the saving path in which the shared information is saved according to the membership account ID of the first local client device. Thus, the users of all of the second local client devices 500 can quickly find the first stage folder and the shared information saved in the first stage folder. However, the invention is not limited to those descriptions. Because the users of all of the second local client devices 500 can quickly find the shared information by triggering the shortcut link 900, the shared information does not have to be saved according to the predetermined set given by a vendor of the cloud server 200, or from the preference sets, or storing location (i.e. name of saving path). The shared information is at least one file or a folder having at least one file. The file can be defined as one of all objects being used, activated or viewed by a computer with compatible application software. The folder can be defined as an object containing the files therein, and can be copied, moved or deleted together with the contained files. The folder also includes a ZIP file.

Moreover, in practice, those elements mentioned above in the aforementioned cloud server 200 and each local client device may be implemented by software to operate their own tasks, or by firmware stored in controller chips or electrical elements to operate their own tasks.

In the method for notification and providing quick link of shared information synchronized to location, when the shared information is synchronized to the shared local client device, a shortcut link for instantly finding and activating the shared information in the shared local client device can be provided to the shared local client device sooner or later.

The method for notification and providing quick link of shared information synchronized to location may take the form of a computer program product stored on a computer-readable storage medium having computer-readable instructions embodied in the medium. Any suitable storage medium may be used. In some embodiments, such suitable storage medium may be a non-transitory computer readable storage medium including non-volatile memory such as read only memory (ROM), programmable read only memory (PROM), erasable programmable read only memory (EPROM), and electrically erasable programmable read only memory (EEPROM) devices; volatile memory such as static random access memory (SRAM), dynamic random access memory (DRAM), and double data rate random access memory (DDR-RAM); optical storage devices such as compact disc read only memories (CD-ROMs) and digital versatile disc read only memories (DVD-ROMs); and magnetic storage devices such as hard disk drives (HDD) and floppy disk drives. In other embodiments, other suitable storage mediums may be used, which should not be limited in this invention.

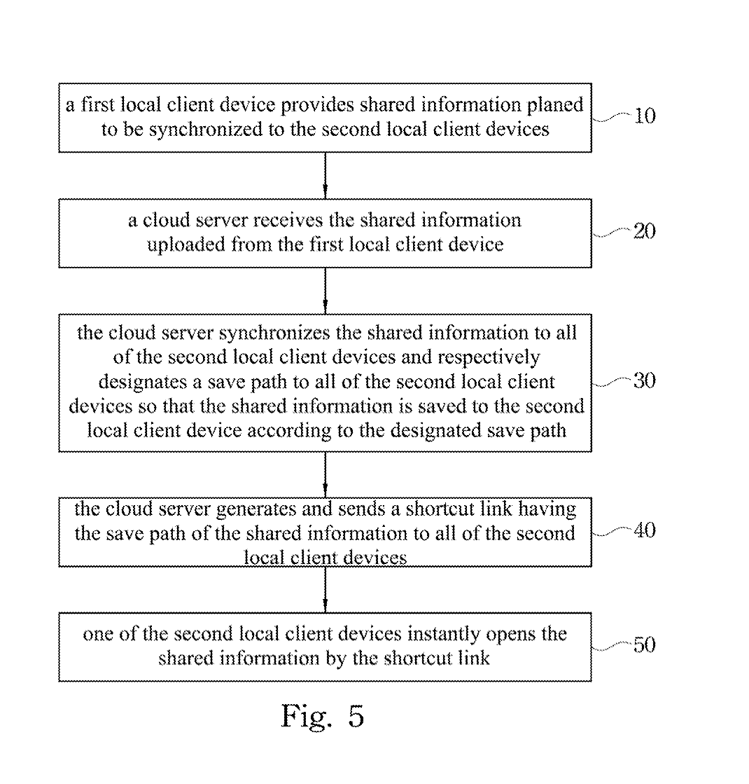

FIG. 5 is a flow chart showing a method for notification and providing quick link of shared information synchronized to location, according to an embodiment of the present invention.

Referring to FIG. 1 and FIG. 5, according to the method for notification and providing quick link of shared information synchronized to location, the embodiment of the present invention includes the following steps.

In Step 10, the first local client device 400 provides shared information planed to be synchronized to the second local client devices 500. In Step 20, the cloud server 200 receives the shared information uploaded from the first local client device 400. In Step 30, the cloud server 200 synchronizes the shared information to all of the second local client devices 500 and respectively designates a saving path to all of the second local client devices 500, such that the shared information is saved to the second local client device 500 according to the designated saving path. In Step 40, the cloud server 200 generates and sends a shortcut link 900 containing the saving path of the shared information to all of the second local client devices 500. In Step 50, one of the second local client devices 500 instantly opens for activates) the shared information by using the shortcut link 900.

Referring to FIG. 1 to FIG. 3, the details of the method for notification and providing quick link of shared information synchronized to location in one embodiment are provided as below, but embodiments of this invention are not limited thereto.

Substantially, in Step 10, when a latest version of the shared information is moved into a specific storage location of the storage unit 650 of the first local client device 400 for synchronization, the agent program module 640 of the first local client device 400 will detect that the shared information is placed in the specific storage location of the storage unit 650 of the first local client device 400. Thereafter, the latest version of the shared information is transmitted to the cloud server 200 by the second network interface unit 610 via the network 300.

In Step 20, the control unit 250 of the cloud server 200 requests the data synchronization module 220 to receive the shared information by the first network interface unit 210 via the network 300, and the control unit 250 backs up the shared information into the file content database 270 according to a first membership account ID used by the first local client device 400.

In Step 30, the control unit 250 of the cloud server 200 matches and finds out all of the second membership account IDs chosen to be shared information by the first membership account ID in the membership database 260, and synchronizes the shared information to all of the second local client devices 500 according to the second membership account IDs. The data synchronization module 220 designates a predetermined saving path, such that the shared information can be saved to the second local client device 500 according to the designated saving path.

At this moment, the agent program module 640 of each of the second local client devices 500 requests the second network interface unit 610 to receive the synchronized shared information, and to store the synchronized shared information in a specific storage location of the storage unit 650 of the second local client device 500 according to the saving path designated by the cloud server 200.

In one variation of the present invention, when the agent program module 640 of the second local client device 500 identifies that the saving path of the second local client device 500 has existed, the agent program module 640 of the second local client device 500 arranges the synchronized shared information stored in the specific storage location of the storage unit 650 corresponding to the saving path.

Otherwise, when the agent program module 640 of the second local client device 500 identifies that the saving path of the second local client device 500 is not existed, the agent program module 640 creates a new folder according to the saving path designated by the cloud server 200, and names the first stage folder of the new folder according to the first membership account ID of the first local client device. In options of the present invention, Step 20 and Step 30 can be performed sequentially or simultaneously.

In Step 40, when the control unit 250 of the cloud server 200 detects that the shared information is uploaded to the second local client devices 500 by the first local client devices 400, the control unit 250 of the cloud server 200 requests the shortcut generator 230 to produce a shortcut link 900 corresponding to a saving path of the shared information stored in the second local client devices 500. The control unit 250 of the cloud server 200 requests the message management module 240 to produce a message, and to generate the shortcut link 900 in the message. The control unit 250 of the cloud server 200 further requests the message management module 240 to send the message having the shortcut link 900 to all of the second local client devices 500 by the first network interface unit 210 according to the contact information of all of the second membership account ID(s) in the membership database 260.

At this moment, when the message module 620 of each of the second local client devices 500 receives the message by the second network interface unit 610, the users of the second local client devices 500 can be instantly informed that the first local client device 400 is processing the synchronization task of the shared information to all of the second local client devices 500 by the message module 620.

For example, as mentioned above, when the message is the e-mail 700, the message management module 240 of the cloud server 200 respectively sends a plurality of copies of the e-mail 700 to mail servers (not shown in figures) of the second local client devices 500 according to the e-mail addresses of the second local client devices 500, respectively, such that the message module 620 (e-mail program, e.g., Outlook Express®) of each of the second local client devices 500 can receive the message.

When the message is the message 800 of instant messaging software, the message management module 240 of the cloud server 200 respectively sends a plurality of copies of the message 800 to message exchange servers (not shown in figures) of the second local client devices 500 according to the account IDs of the instant messaging software of the second local client devices 500, respectively, so that the message module 620 (instant messaging software application, e.g., MSN®) of each of the second local client devices 500 can receive the message.

When the message is the short message of Short Message Service (SMS), the message management module 240 of the cloud server 200 respectively sends a plurality of copies of the short message to a message exchange room (not shown in figures) of the second local client devices 500 according to the mobile phone numbers of the second local client devices 500, respectively, such that the message module 620 (short message application, e.g., MMS®) of each of the second local client devices 500 can receive the message. In alternatives of the present invention, Step 30 and Step 40 can be performed simultaneously, or after the shared information of the synchronization tasks of Step 30 is completed, the message of Step 40 is then sent to all of the second local client devices 500. However, the order of Step 30 and Step 40 in this invention should not be limited thereto.

In Step 50, when a user of one of the second local client devices 500 chooses to trigger the shortcut link 900, the web page browser module 630 of the second local client devices 500 is triggered to send a request to a Http server in the agent program module 640 of the second local client device 500, and then, the web page browser module 630 of the second local client devices 500 is then disabled. The agent program module 640 of the second local client devices 500 activates the respective shared information according to the shortcut link 900.

In one optional variation of the present invention, when the cloud server 200 in Step 20 receives the shared information uploaded from the first local client device 400, the cloud server 200 determines whether the shared information is uploaded from the first local client device 400 at a first time. If yes, Step 30 is then performed, otherwise, only the shared information is synchronized to all of the second local client devices 500 without performing Step 30. Thus, too many messages containing shortcut link 900 therein provided to all of the second local client devices 500 will be prevented.

To sum up, in the present invention, the method, system and computer readable storage medium for notification and providing quick link of shared information synchronized to location can provide the shared user of the local client device to instantly find and activate the shared information right away, later, or when needing to view the shared information, or even when the local client device disconnecting with networks, by triggering the shortcut link without needing to check and find the shared information via a lengthy saving path which is prolix and unfamiliar, thus shortening working time and increasing working effectiveness.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims. Although specific terms are employed herein, they are used in a generic and descriptive sense only and not for purposes of limitation.

Although the present invention has been described with reference to the preferred embodiments thereof, it is apparent to those skilled in the art that a variety of modifications and changes may be made without departing from the scope of the present invention which is intended to be defined by the appended claims.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A method for notification and providing quick link of shared information synchronized to location, which is applicable to a cloud server, the method comprising:
(a) receiving shared information uploaded from a first local client device via a network:
(b) synchronizing and distributing the shared information to at least one second local client device on the networks, and designating a predetermined saving path through which the shared information is saved to the second local client device; and
(c) generating and sending a shortcut link to the second local client device, wherein when the shortcut link is triggered in the second local client device, the shared information is activated instantly.

2. The method according to claim 1, wherein the step (c) further comprises:
obtaining contact information for contacting the second local client device according to a membership account ID of the first local client device; and
sending a message containing the shortcut link to the second local client device according to the contact information.

3. The method according to claim 2, wherein a first stage folder of the saving path is named according to the membership account ID of the first local client device.

4. The method according to claim 2, wherein the contact information is an e-mail address, an account ID of an instant messaging software or a mobile phone number.

5. The method according to claim 2, wherein the step (c) further comprises:
writing background information of the first local client device and the shared information into the message.

6. The method according to claim 2, wherein the message is an e-mail, a message of an instant messaging software or a short message of Short Message Service.

7. The method according to claim 6, wherein when the message is the e-mail, the shortcut link exists in a content of the e-mail or in an attached file of the e-mail.

8. The method according to claim 1, wherein the shared information is at least one file or a folder having at least one file.

9. The method according to claim 1, wherein after it is determined that the step (b) is completed, the step (c) is then performed.

10. The method according to claim 1, wherein the step (b) and the step (c) are performed simultaneously.

11. The method according to claim 1, wherein the step (b) further comprises:
after it is determined that the shared information is uploaded from the first local client device at a first time, the step (c) is then performed.

12. A system for notification and providing quick link of shared information synchronized to location, the system comprising:
a first local client device;
a second local client device; and
a cloud server, comprising:
a network interface unit for establishing a connection with the first local client device and the second local client device via a network;
a data synchronization module for synchronizing shared information from the first local client device to the second local client device via the network interface unit, and designating a predetermined saving path through which the shared information is saved to the second local client device; and
a shortcut link generator for generating a shortcut link according to the predetermined saving path,
wherein the shortcut link is sent to the second local client device via the network interface unit, and when the shortcut link is triggered in the second local client device, the shared information will be activated instantly.

13. The system according to claim 12, further comprising:
a message management module electrically connected to the network interface unit and the shortcut link generator for providing and sending a message containing the shortcut link to the second local client device via the network interface unit according to contact information of the second local client device.

14. The system according to claim 12 further comprising:
a membership database comprising a membership account ID of the first local client device, and the contact information of the second local client device chosen to be shared with information from the first local client device.

15. The system according to claim 14, wherein a first stage folder of the saving path is named according to the membership account ID of the first local client device.

16. The system according to claim 12, wherein the second local client device comprises:
a storage unit; and
an agent program module electrically connected to the storage unit for saving the shared information synchronized from the cloud server to the storage unit according to the saving path designated by the cloud server.

17. The system according to claim 12, wherein the contact information is an e-mail address, an account ID of an instant messaging software or a mobile phone number.

18. The system according to claim 17, wherein the message is an e-mail, a message of an instant messaging software or a short message of Short Message Service.

19. The system according to claim 18, wherein the shortcut link exists in a content of the e-mail or in an attached file of the e-mail.

20. A non-transitory computer readable storage medium with a computer program to execute a method for notification and providing quick link of shared information synchronized to location, wherein the method for notification and providing quick link of shared information synchronized to location comprises:
(a) receiving a shared information uploaded from a first local client device via a network;
(b) synchronizing and distributing the shared information to at least one second local client device on the network, and designating a predetermined saving path through which the shared information is saved to the second local client device; and
(c) generating and sending a shortcut link to the second local client device, wherein when the shortcut link is triggered in the second local client device, the shared information will be activated instantly.
